(19) United States
(12) Patent Application Publication
(10) Pub. No.: US 2026/0307054 A1
(43) Pub. Date: Oct. 8, 2026

(54) INTERMETALLIC CATALYST COMPLEX FOR ELECTROCHEMICAL DEVICE AND METHOD OF MANUFACTURING SAME

(71) Applicants: Hyundai Motor Company, Seoul (KR); Kia Corporation, Seoul (KR)

(72) Inventors: Jun Seog Park, Hwaseong (KR); Young Jung Heo, Hwaseong (KR); Junu Bak, Hwaseong (KR)

(21) Appl. No.: 19/330,564

(22) Filed: Sep. 16, 2025

(30) Foreign Application Priority Data
Apr. 7, 2025 (KR) 10-2025-0044484

(51) Int. Cl. B01J 23/62; B01J 21/02; B01J 23/60; B01J 27/057; B01J 27/24; B01J 35/45; B01J 35/53; B01J 37/04; B01J 37/08; B01J 37/16

(52) U.S. Cl. CPC B01J 23/62; B01J 21/02; B01J 23/60; B01J 23/626; B01J 27/0573; B01J 27/24; B01J 35/45; B01J 35/53; B01J 37/04; B01J 37/08; B01J 37/16

(57) ABSTRACT

An intermetallic catalyst complex for fuel-cell electrode is provided. A core made of platinum and transition metals M1 and M2 is first formed with a highly ordered L1₀/L1₂ lattice; an acid step then strips surface M2 to leave a thin platinum shell, increasing oxygen-reduction activity and durability. The process begins by doping a carbon or metal-oxide support with low-melting point metal M1, followed by co-reduction of Pt and M2 and a final acid treatment. The resulting nanoparticles, 1.5-4.5 nm in diameter with 0.2-1.5 nm shells, suppress metal dissolution and maintain performance under acidic fuel-cell conditions.

### CROSS-REFERENCE TO RELATED APPLICATION

This application claims, under 35 U.S.C. § 119(a), the benefit of Korean Patent Application No. 10-2025-0044484, filed on Apr. 7, 2025, the entire contents of which are incorporated herein by reference.

### BACKGROUND

### Technical Field

The present disclosure relates to an intermetallic catalyst complex for an electrochemical device and a method of manufacturing the complex. In particular, fuel-cell performance and durability are enhanced by introducing a low-melting-point metal during fabrication of the intermetallic catalyst complex.

### Background

Electrochemical devices operate through redox reactions and associated electron transfer between materials. Representative examples thereof include fuel cells using proton exchange membranes or polymer electrolyte membranes (PEMs) and devices to which carbon dioxide reduction reaction (CO₂RR) technology for converting carbon dioxide into useful compounds by electrochemical reduction is applied.

The proton exchange membrane fuel cell is an electricity generator using hydrogen fuel that has the advantages of high energy efficiency, simple system configuration, and being environmentally friendly. Proton exchange membrane fuel cells are receiving attention as energy converters for eco-friendly vehicles.

Electricity generation in a fuel cell occurs in a membrane-electrode assembly (MEA) including a perfluorinated sulfonic acid (PFSA) ionomer-based membrane and electrodes such as an anode/cathode. After hydrogen supplied to the anode, which is the oxidation electrode of the fuel cell, is separated into protons and electrons (hydrogen oxidation reaction; HOR), the protons move through the membrane to the cathode, which is the reduction electrode, and the electrons move to the cathode through an external circuit. At the cathode, oxygen molecules, protons, and electrons react together in the oxygen-reduction reaction (ORR), generating electricity, heat and water (H₂O).

As such, since oxygen reduction reaction occurring at the cathode has a lower reaction rate than hydrogen oxidation reaction, a larger amount of catalyst is used at the cathode. As a cathode catalyst, a Pt/C catalyst complex in which a platinum catalyst is supported on a carbon support is mainly used, but a large amount of platinum is still used, and thus there is a need for a method capable of further increasing oxygen reduction reaction activity.

To this end, attempts have been made to use alloys of platinum and transition metal, but durability may deteriorate due to excessive dissolution of the transition metal during operation of the fuel cell. Consequently, a catalyst with a novel structure capable of sustaining high activity while resisting metal dissolution is required.

### SUMMARY

The present disclosure has been made keeping in mind the problems encountered in the related art, and embodiments of the present disclosure is to provide a catalyst complex for a fuel cell and a method of manufacturing the same, in which a phenomenon in which a transition metal capable of alloying with platinum is excessively dissolved during operation of a fuel cell is solved.

In particular, the present disclosure is intended to provide a method of manufacturing an intermetallic catalyst complex having an intermetallic structure even under low-temperature heat treatment conditions using a metal having a relatively low melting point during the process of manufacturing the intermetallic catalyst complex.

The embodiments of the present disclosure are not limited to the foregoing. The embodiments of the present disclosure will be able to be clearly understood through the following description and to be realized by the means described in the claims and combinations thereof.

Some embodiments of the present disclosure provide an intermetallic catalyst complex for an electrochemical device, including a support and an intermetallic catalyst supported on the support, in which the intermetallic catalyst includes a core having an intermetallic structure and including a first heterometal (M1), a second heterometal (M2), and platinum (Pt) and a shell covering at least a portion of a surface of the core and including platinum (Pt).

In some embodiments, the core may include a first core portion including platinum (Pt), a first heterometal (M1), and a second heterometal (M2) and a second core portion located outside the first core portion and including platinum (Pt) and a second heterometal (M2).

In some embodiments, the second core portion may further include a first heterometal (M1), and, in the second core portion, the amount of the second heterometal (M2) may be greater than the amount of the first heterometal (M1).

In some embodiments, the support may be doped with at least one element of nitrogen (N), oxygen (O), or boron (B).

In some embodiments, the first heterometal (M1) may include a metal having a melting point of 420° C. or less.

In some embodiments, the first heterometal (M1) may include at least one of gallium (Ga), zinc (Zn), tin (Sn), or selenium (Se).

In some embodiments, the second heterometal (M2) may include at least one of cobalt (Co), nickel (Ni), iron (Fe), copper (Cu), manganese (Mn), or zinc (Zn).

In some embodiments, the average size of the core may be 1.5 nm to 4.5 nm.

In some embodiments, the average thickness of the shell may be 0.2 nm to 1.5 nm.

In some embodiments, the core may include at least one crystal structure of L1₀ or L1₂.

In some embodiments, an element ratio of platinum (Pt) to a sum of the first heterometal (M1) and the second heterometal (M2) in the intermetallic catalyst complex may satisfy 1:1 to 5:1.

In some embodiments, the intermetallic catalyst complex may include 0.1 wt. % to 10 wt. % of the first heterometal (M1) based on the total weight of the intermetallic catalyst complex.

In some embodiments, the degree of ordering (I₍₁₁₀₎/I₍₁₁₁₎*100) determined by XRD analysis of the intermetallic catalyst complex may satisfy 5% to 40%.

Some embodiments of the present disclosure provides a method of manufacturing an intermetallic catalyst complex for an electrochemical device, including preparing a first mixture by mixing a support, a first heterometal precursor, and an organic precursor with a first solvent, doping the support with a first heterometal (M1) by heating the first mixture, preparing a second mixture by mixing the support doped with the first heterometal (M1), a platinum precursor, and a second heterometal precursor with a second solvent, forming a core having an intermetallic structure by reducing platinum (Pt) and a second heterometal (M2) on the surface and inside of the first heterometal (M1) by heat treatment of the second mixture, and forming a shell by removing the second heterometal (M2) located on an outermost surface of the core by acid treatment of the core.

In some embodiments, the core may include a first core portion including platinum (Pt), a first heterometal (M1), and a second heterometal (M2) and a second core portion located outside the first core portion and including platinum (Pt) and a second heterometal (M2).

In some embodiments, metal particles of the first heterometal (M1) may be used to dope the support.

In some embodiments, the support may be doped with the first heterometal (M1) and at least one element of nitrogen (N), oxygen (O), or boron (B) derived from the organic precursor by heating the first mixture.

In some embodiments, the first heterometal (M1) precursor may include a compound in which the first heterometal (M1) is bonded to at least one functional group of an acetylacetonate group, a chloride group, a bromide group, an iodide group, a nitrate group, or a sulfate group, and the second heterometal (M2) precursor may include a compound in which the second heterometal (M2) is bonded to at least one functional group of an acetylacetonate group, a chloride group, a bromide group, an iodide group, a nitrate group, or a sulfate group.

In some embodiments, the organic precursor may include at least one of DCDA (dicyandiamide), urea, melamine, maleic acid, tartaric acid, boric acid, or cyanuric acid.

In some embodiments, the platinum precursor may include at least one of chloroplatinic acid, platinum acetylacetonate, platinum chloride, platinum bromide, or platinum iodide.

In some embodiments, the organic precursor may be added in an amount of 0.05 wt. % to 5 wt. % based on the total weight of a solid material in the first mixture.

In some embodiments, the first heterometal precursor may be added so that the amount of the first heterometal satisfies 0.4 wt. % to 20 wt. % based on the weight of the support.

In some embodiments, the first mixture may be heated to a temperature of 300° C. to 800° C., and the second mixture may be heated to a temperature of 400° C. to 700° C.

In some embodiments, provided is a intermetallic catalyst complex for an electrochemical device, the intermetallic catalyst complex comprising a support; and an intermetallic catalyst supported on the support, the intermetallic catalyst comprising: a core having an intermetallic structure and comprising a first heterometal (M1), a second heterometal (M2), and platinum (Pt); and a shell disposed on at least a portion of a surface of the core and comprising platinum (Pt).

The core may include a first core portion comprising platinum (Pt), a first heterometal (M1), and a second heterometal (M2); and a second core portion that encases the first core portion and comprising platinum (Pt) and a second heterometal (M2).

The second core portion may further include a first heterometal (M1), and, in the second core portion, an amount of the second heterometal (M2) is greater than an amount of the first heterometal (M1).

The support may be doped with at least one of nitrogen (N), oxygen (O), or boron (B).

The first heterometal (M1) may include a metal having a melting point of 420° C. or lower.

The first heterometal (M1) may include at least one of gallium (Ga), zinc (Zn), tin (Sn), or selenium (Se).

The second heterometal (M2) may include at least one of cobalt (Co), nickel (Ni), iron (Fe), copper (Cu), manganese (Mn), or zinc (Zn).

An average size of the core may be about 1.5 nm to 4.5 nm.

An average thickness of the shell is about 0.2 nm to 1.5 nm.

The core may exhibit an L1₀ or L1₂ crystal structure.

An element ratio of platinum (Pt) to a sum of the first heterometal (M1) and the second heterometal (M2) in the intermetallic catalyst complex may be about 1:1 to 5:1.

The intermetallic catalyst complex may include about 0.1 wt. % to 10 wt. % of the first heterometal (M1) based on a total weight of the intermetallic catalyst complex.

A degree of ordering, I₍₁₁₀₎/I₍₁₁₁₎*100 calculated from XRD analysis of the intermetallic catalyst complex may be about 5% to 40%.

In some embodiments, provided is a method of manufacturing an intermetallic catalyst complex for an electrochemical device. The method comprises preparing a first mixture by combining a support, a first heterometal precursor, and an organic precursor with a first solvent; heating the first mixture to dope the support with a first heterometal (M1); preparing a second mixture by combining the doped support, a platinum precursor, and a second heterometal precursor with a second solvent; heat-treating the second mixture to form a core having an intermetallic structure by reducing platinum (Pt) and a second heterometal (M2) on a surface and inside of the first heterometal (M1); and acid-treating the core to remove the second heterometal (M2) located on an outermost surface of the core.

Metal particles of the first heterometal (M1) may be used to dope the support.

The support may be doped with the first heterometal (M1) and at least one of nitrogen (N), oxygen (O), or boron (B) derived from the organic precursor by heating the first mixture, and the organic precursor may comprise at least one of DCDA (dicyandiamide), urea, melamine, maleic acid, tartaric acid, boric acid, or cyanuric acid.

The first heterometal (M1) precursor may comprise a compound in which the first heterometal (M1) is bonded to at least one functional group of an acetylacetonate group, a chloride group, a bromide group, an iodide group, a nitrate group, or a sulfate group, the second heterometal (M2) precursor comprises a compound in which the second heterometal (M2) is bonded to at least one functional group of an acetylacetonate group, a chloride group, a bromide group, an iodide group, a nitrate group, or a sulfate group, and the platinum precursor comprises at least one of chloroplatinic acid, platinum acetylacetonate, platinum chloride, platinum bromide, or platinum iodide.

The organic precursor may be present in an amount of 0.05 wt. % to 5 wt. % based on a total weight of a solid material in the first mixture.

The first heterometal precursor may be charged such that the first heterometal accounts for about 0.4 wt. % to 20 wt. % based on a weight of the support.

The first mixture may be heated at a temperature of about 300° C. to 800° C., and the second mixture may be heated at a temperature of about 400° C. to 700° C.

### BRIEF DESCRIPTION OF THE DRAWINGS

Some embodiments, embodiments, and features of the present disclosure are described in various detail with reference to certain exemplary embodiments that are illustrated in the accompanying drawings. The drawings provided hereinbelow are for purposes of illustration only and are not limited to the embodiments and features of present disclosure or to the claims.

FIG. 1 shows an intermetallic catalyst complex according to some embodiments of the present disclosure;

FIG. 2A schematically shows the atomic structure of a first heterometal with which a support is doped according to some embodiments of the present disclosure;

FIG. 2B schematically shows the atomic structure of a core supported on the support according to some embodiments of the present disclosure;

FIG. 2C schematically shows the core and the shell of an intermetallic catalyst complex according to some embodiments of the present disclosure and the atomic structure in the core and the shell;

FIG. 3 shows an intermetallic structure of the core according to some embodiments of the present disclosure;

FIG. 4 shows a membrane-electrode assembly for an electrochemical device to which the intermetallic catalyst complex according to the present disclosure is applied;

FIG. 5 shows results of high-angle annular dark-field scanning transmission electron microscopy (HAADF-STEM) of an intermetallic catalyst complex according to Comparative Example 1;

FIG. 6 shows results of line scanning of the intermetallic catalyst complex according to Comparative Example 1 using HAADF-STEM-EDS (energy dispersive spectroscopy);

FIG. 7 shows results of high-angle annular dark-field scanning transmission electron microscopy of an intermetallic catalyst complex according to Example;

FIG. 8 shows results of line scanning of the intermetallic catalyst complex according to Example using HAADF-STEM-EDS;

FIG. 9 shows results of X-ray diffraction (XRD) analysis before and after acid treatment during manufacture of the intermetallic catalyst complex according to Example and results of XRD analysis of the catalysts according to Comparative Examples 1 to 3;

FIG. 10 is a graph showing voltage-current curves for membrane-electrode assemblies to which the intermetallic catalyst complexes according to Example and Comparative Examples 1 and 2 are applied;

FIG. 11 is a graph showing results of durability testing of the membrane-electrode assemblies to which the intermetallic catalyst complexes according to Example and Comparative Example 2 are applied; and

FIG. 12(a) is a comparative graph showing a change in durability in the low current density range derived from FIG. 11, and FIG. 12(b) is a comparative graph showing a change in durability in the high current density range.

### DETAILED DESCRIPTION

The above and other embodiments, features and advantages of the present disclosure will be more clearly understood from the following preferred embodiments taken in conjunction with the accompanying drawings. However, the present disclosure is not limited to the embodiments disclosed herein and may be modified into different forms. These embodiments are provided to thoroughly explain the disclosure and to sufficiently transfer the spirit of the present disclosure to those skilled in the art.

Throughout the drawings, the same reference numerals will refer to the same or like elements. For the sake of clarity of the present disclosure, the dimensions of structures are depicted as being larger than the actual sizes thereof. It will be understood that, although terms such as “first”, “second”, etc. may be used herein to describe various elements, these elements are not to be limited by these terms. These terms are only used to distinguish one element from another element. For instance, a “first” element discussed below could be termed a “second” element without departing from the scope of the present disclosure. Similarly, the “second” element could also be termed a “first” element. As used herein, the singular forms are intended to include the plural forms as well, unless the context clearly indicates otherwise.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. As used herein, the term “and/or” includes any and all combinations of one or more of the associated listed items. In addition, the terms “unit”, “-er”, “-or”, and “module” described in the specification mean units for processing at least one function and operation and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules, and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

It will be further understood that the terms “comprise”, “include”, “have”, etc., when used in this specification, specify the presence of stated features, integers, steps, operations, elements, components, or combinations thereof, but do not preclude the presence or addition of one or more other features, integers, steps, operations, elements, components, or combinations thereof. Also, it will be understood that when an element such as a layer, film, area, or sheet is referred to as being “on” another element, it may be directly on the other element, or intervening elements may be present therebetween. Similarly, when an element such as a layer, film, area, or sheet is referred to as being “under” another element, it may be directly under the other element, or intervening elements may be present therebetween.

Unless otherwise specified, all numbers, values, and/or representations that express the amounts of components, reaction conditions, polymer compositions, and mixtures used herein are to be taken as approximations including various uncertainties affecting measurement that inherently occur in obtaining these values, among others, and thus should be understood to be modified by the term “about” in all cases. Furthermore, when a numerical range is disclosed in this specification, the range is continuous and includes all values from the minimum value of said range to the maximum value thereof, unless otherwise indicated. Moreover, when such a range pertains to integer values, all integers including the minimum value to the maximum value are included, unless otherwise indicated.

In the present specification, when a range is described for a variable, it will be understood that the variable includes all values including the end points described within the stated range. For example, the range of “5 to 10” will be understood to include any subranges, such as 6 to 10, 7 to 10, 6 to 9, 7 to 9, and the like, as well as individual values of 5, 6, 7, 8, 9 and 10, and will also be understood to include any value between valid integers within the stated range, such as 5.5, 6.5, 7.5, 5.5 to 8.5, 6.5 to 9, and the like. Also, for example, the range of “10% to 30%” will be understood to include subranges, such as 10% to 15%, 12% to 18%, 20% to 30%, etc., as well as all integers including values of 10%, 11%, 12%, 13% and the like up to 30%, and will also be understood to include any value between valid integers within the stated range, such as 10.5%, 15.5%, 25.5%, and the like.

Furthermore, unless specifically stated otherwise, the term “about” as used herein may be understood within a range of error that is typical in the art (e.g., within 2 standard deviations of the mean). “About” may be understood as within 10%, 9%, 8%, 7%, 6%, 5%, 4%, 3%, 2%, 1%, 0.5%, 0.1%, 0.05%, or 0.01% of the stated value.

The term “heterometal” as used herein refers to any metal element other than platinum that is incorporated into the intermetallic core.

The term “intermetallic catalyst” as used herein refers to a catalytic nanoparticle that possesses an ordered intermetallic crystal lattice formed by platinum and at least one heterometal.

The term “intermetallic catalyst complex” as used herein refers to a composite that includes the intermetallic catalyst, as defined above, immobilized on a support.

### Intermetallic Catalyst Complex for Electrochemical Device

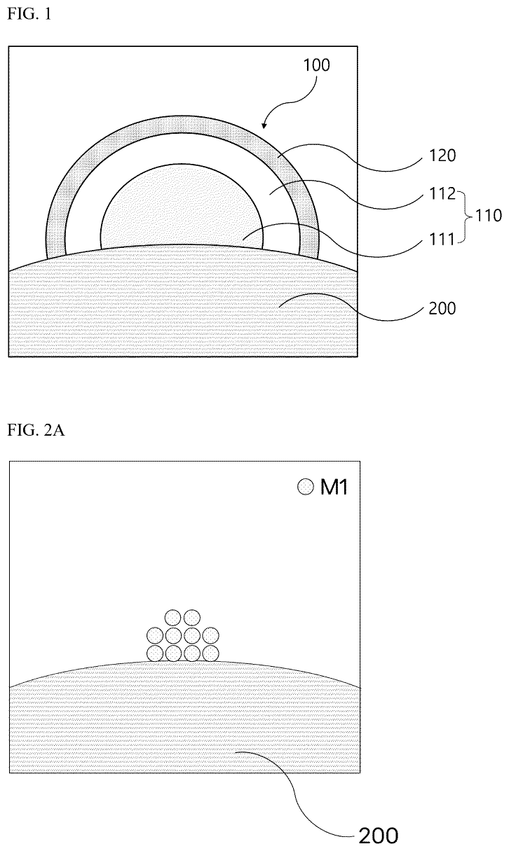

FIG. 1 shows an intermetallic catalyst complex for an electrochemical device according to an embodiment of the present disclosure.

The electrochemical device is a device using redox reaction and various phenomena caused by the transfer of electrons between materials, and representative examples thereof include fuel cells using proton exchange membranes (PEMs) and devices to which carbon dioxide reduction reaction (CO₂RR) technology for converting carbon dioxide into useful compounds by electrochemical reduction is applied. In the fuel cells using PEMs and devices to which carbon dioxide reduction reaction technology is applied, a catalyst or catalyst complex capable of lowering reaction activation energy in the process of inducing redox reaction may be used.

Unless described otherwise below, the intermetallic catalyst complex according to the present disclosure is described based on application thereof to a proton exchange membrane fuel cell, and the same effect may be obtained even when the catalyst complex according to the present disclosure is used for the electrode of a device to which carbon dioxide reduction reaction technology is applied.

An intermetallic catalyst complex according to some embodiments of the present disclosure includes a support 200 and an intermetallic catalyst 100 supported on the support 200, in which the intermetallic catalyst 100 may include a core 110 having an intermetallic structure and including platinum (Pt), a first heterometal (M1), and a second heterometal (M2) and a shell 120 covering at least a portion of the surface of the core 110 and including platinum (Pt). Preferably, the surface of the core 110 is completely covered by the shell 120.

In some embodiments, the core 110 of the intermetallic catalyst 100 supported on the support 200 may be formed by alloying of platinum and a first heterometal and/or a second heterometal and may exhibit excellent oxygen reduction reactivity. In addition, the platinum shell covering the surface of the core 110 may serve to suppress dissolution of the first heterometal and/or the second heterometal. In addition, the intermetallic catalyst 100 including the core 110 is able to suppress dissolution of the first or second heterometal during operation of the fuel cell by forming an intermetallic compound in which platinum, the first heterometal, and/or the second heterometal are configured to have a regular atomic arrangement.

In this way, the intermetallic catalyst complex according to an embodiment of the present disclosure is able to prevent a phenomenon of decreasing the effect of improving performance and durability due to the intermetallic structure by destroying the intermetallic structure of the intermetallic catalyst complex due to dissolution of the first heterometal (M1) during operation of the fuel cell. Also, it is possible to resolve a phenomenon in which the activity of the catalyst itself is decreased due to excessive dissolution of the second heterometal (M2) during operation of the fuel cell, and a phenomenon in which the ionomer and electrolyte membrane are poisoned by the dissolved second heterometal (M2), adversely affecting durability of the fuel cell.

In some embodiments, the support 200 is not particularly limited so long as it is commonly used in the art, and examples thereof may include a carbon-based support and/or a metal oxide-based support.

In some embodiments, the carbon-based support may include at least one of carbon black, mesoporous carbon, carbon nanotubes, graphite, or graphene. The carbon black may include acetylene black, Denka black, Ketjen black, etc.

In some embodiments, the metal oxide-based support may include at least one of ZrO₂, MgO, TiO₂, Al₂O₃, SiO₂, CrO₂, Fe₂O₃, Fe₃O₄, CuO, ZnO, CaO, Sb₂O₄, Co₃O₄, Pb₃O₄, Mn₃O₄, Ag₂O₂, U₃O₈, Cu₂O, Li₂O, Rb₂O, Ag₂O, Tl₂O, BeO, CdO, TiO, GeO₂, HfO₂, PbO₂, MnO₂, SnO₂, La₂O₃, CeO₂, WO₂, UO₂, ThO₂, TeO₂, or MoO₃.

In some embodiments, the core 110 may include a first core portion 111 including platinum (Pt), a first heterometal (M1), and a second heterometal (M2) and a second core portion 112 located outside the first core portion 111 and including platinum (Pt) and a second heterometal (M2). The first core portion 111 and the second core portion 112 may be distinguished depending on the concentration or amount of the first heterometal (M1) distributed in the core 110.

Specifically, the region in which the first heterometal (M1) is mainly distributed in the core 110 may be referred to as the first core portion 111, and the remaining region may be referred to as the second core portion 112. In some embodiments, the second core portion 112 may further include a portion of the first heterometal (M1) in addition to platinum (Pt) and the second heterometal (M2), in which the amount of the first heterometal may be less than that of the second heterometal.

Here, the fact that the first heterometal (M1) is mainly distributed means that the distribution of the first heterometal (M1) in the core 110 is analyzed using known technology in the relevant field, and 50% or more, 60% or more, 70% or more, 80% or more, 90% or more, 95% or more, or 99% or more of the first heterometal (M1) is included using a method such as a cumulative distribution function, and this radius may be set as the boundary between the first core portion 111 and the second core portion 112.

According to an embodiment of the present disclosure, since the first heterometal (M1) is mainly distributed in the first core portion 111, the first heterometal (M1) is not exposed to the surface of the intermetallic catalyst 100 during the process of manufacturing the intermetallic catalyst complex, and thus, an intermetallic structure may be maintained even during the acid treatment process described later. Accordingly, an intermetallic catalyst complex with high performance and high durability may be manufactured.

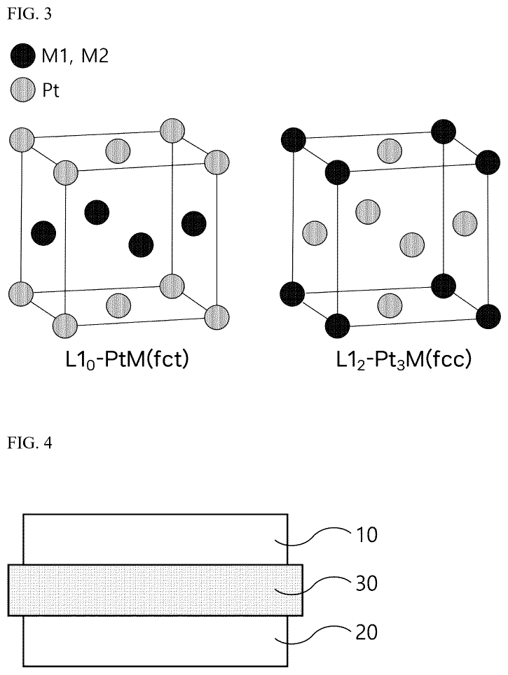

In some embodiments, the core 110 may include at least one crystal structure of L1₀ or L1₂. FIG. 3 shows an intermetallic structure L1₀ or L1₂ of the core 110 according to an embodiment of the present disclosure. Referring to FIG. 3, the L1₀ structure may be understood as platinum (Pt) and heterometals (M1, M2) forming an FCT (face-centered tetragonal) lattice structure, and the L1₂ structure may be understood as platinum (Pt) and heterometals (M1, M2) forming an FCC (face-centered cubic) lattice structure.

In some embodiments, the shell 120 including platinum (Pt) may be formed on at least a portion of the surface of the core 110. Preferably, the shell 120 includes platinum (Pt) as a main component, and more preferably, the shell 120 is composed of platinum (Pt). Here, the meaning that the shell 120 includes platinum (Pt) as a main component is that the weight of platinum (Pt) included in the shell 120 is greater than the weight of other elements, for example, the second heterometal (M2).

Also, the shell 120 may be derived from the core 110. In particular, the shell 120 may be derived from the second core portion 112. The meaning that the shell 120 is derived from the core 110 or the second core portion 112 may be understood as the shell 120 being formed by removing the second heterometal (M2) located on the outermost surface of the core 110 or the second core portion 112 through acid treatment.

According to an embodiment of the present disclosure, the shell 120 may be formed into a uniform platinum shell (i.e., shell) on the outermost surface of the intermetallic catalyst complex as it is derived from the core 110 or the second core portion 112. Accordingly, the first heterometal (M1) and the second heterometal (M2) may be more effectively prevented from being dissolved out of the intermetallic catalyst complex.

In some embodiments, the element ratio of platinum (Pt) to the sum of the first heterometal (M1) and the second heterometal (M2) included in the intermetallic catalyst complex may satisfy 1:1 to 5:1.

FIG., shows that when the element ratio of platinum (Pt) to the heterometals (M1, M2) is between 1:1 and 3:1, the core 110 may have an L1₀ structure. This may have an L1₀ structure when the element ratio of platinum (Pt) to the heterometals (M1, M2) included in the core 110 as shown in FIG. 3 is about 1:1, and since the intermetallic catalyst complex includes the shell 120 including platinum (Pt) as a main component, it may be understood that the element ratio of platinum (Pt) increases to 3:1 from 1:1.

In addition, when the element ratio of platinum (Pt) to the heterometals (M1, M2) satisfies 3:1 to 5:1, the core 110 may have an L1₂ structure. This may have an L1₂ structure when the element ratio of platinum (Pt) to the heterometals (M1, M2) included in the core 110 as shown in FIG. 3 is about 3:1, and since the intermetallic catalyst complex includes the shell 120 including platinum (Pt) as a main component, it may be understood that the element ratio of platinum (Pt) increases to 5:1 from 3:1.

In some embodiments, the first heterometal (M1) may be included in an amount of 0.1 wt. % to 10 wt. % based on the total weight of the intermetallic catalyst complex. Preferably, the first heterometal (M1) is included in an amount of 1 wt. % to 5 wt. %. If the amount of the first heterometal is too low, the effect of improving performance and durability of the intermetallic catalyst complex may not be sufficient, whereas if the amount of the first heterometal is too high, the Pt-M2 alloying effect may decrease due to an excess of first heterometal.

In some embodiments, the first heterometal (M1) may be a low-melting-point metal including a metal element having a melting point of 420° C. or less. The first heterometal (M1) may serve to lower the energy barrier for forming an intermetallic structure, so that an intermetallic catalyst 100 having an intermetallic structure may be manufactured even under low-temperature heat treatment conditions. Any first heterometal may be used without particular limitation so long as it is a low-melting-point metal, and for example, the first heterometal (M1) may include at least one of gallium (Ga), zinc (Zn), tin (Sn), or selenium (Se).

In some embodiments, the second heterometal (M2) includes a transition metal, and specifically, any metal may be used without particular limitation so long as it is able to form an intermetallic structure with platinum (Pt) among the 4^{th} period 3d transition metals or platinum and the first heterometal (M1) to thus further increase the activity of oxygen reduction reaction of the catalyst. For example, the second heterometal (M2) may include at least one of cobalt (Co), nickel (Ni), iron (Fe), copper (Cu), manganese (Mn), or zinc (Zn). Preferably, at least one of cobalt (Co), nickel (Ni), or iron (Fe) is used.

In some embodiments, the intermetallic catalyst 100 supported on the support 200 may have a nanoscale size. For example, the average size (D50) of the intermetallic catalyst 100 may be 1 nm to 50 nm, 1 nm to 30 nm, or 1 nm to 10 nm. In some embodiments, the average size of the core 110 may be 1.5 nm to 4.5 nm. Also, in some embodiments, the average thickness of the shell 120 may be 0.2 nm to 1.5 nm. When the size of the core 110 satisfies the above numerical range, the active area of the intermetallic catalyst 100 may increase, thereby increasing catalytic performance. Also, when the size of the shell 120 satisfies the above numerical range, dissolution of the first heterometal and/or the second heterometal during operation of the fuel cell may be minimized.

In some embodiments, the support 200 may be doped with at least one element of nitrogen (N), oxygen (O), or boron (B). Here, nitrogen, oxygen, or boron may serve to assist in doping the support 200 with the first heterometal in the form of metallic state particles rather than oxides by creating defective sites on the support 200.

Here, nitrogen, oxygen, or boron with which the support 200 is doped is derived from an organic precursor, and as will be described later, rather than using a support 200 already doped with nitrogen, oxygen or boron, it is preferable that nitrogen, oxygen or boron be used for doping during the process along with the first heterometal.

In some embodiments, the degree of ordering (I₍₁₁₀₎/I₍₁₁₁₎*100) determined by XRD analysis of the intermetallic catalyst complex may satisfy 5% to 40%. The degree of ordering is expressed as a numerical value of the intensity ratio of the (110) lattice peak observed at 2θ=about 32° to 38° and the (111) lattice peak observed at 2θ=about 39° to 43° by XRD analysis of the intermetallic catalyst complex. If the degree of ordering is less than 5%, the intermetallic structure of the intermetallic catalyst may not be formed or the intermetallic structure may disappear due to dissolution of the first and second heterometals. On the other hand, if the degree of ordering exceeds 40%, the shell 120 may be provided in an alloy form rather than a platinum shell, and the second heterometal may be exposed to the outside, which may cause a decrease in performance and durability of the intermetallic catalyst 100.

### Method of Manufacturing Intermetallic Catalyst Complex for Electrochemical Device

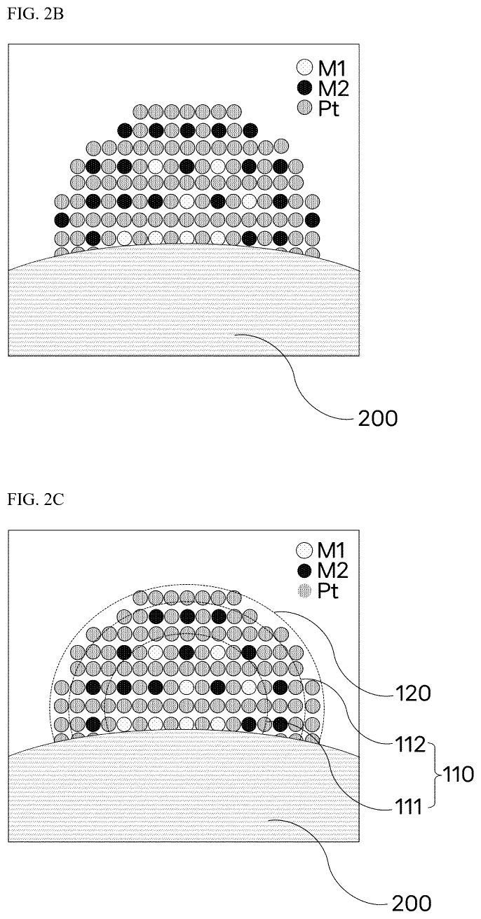

FIGS. 2A to 2C show a process of manufacturing an intermetallic catalyst complex for an electrochemical device according to an embodiment of the present disclosure. Specifically, FIG. 2A schematically shows the atomic structure of the first heterometal with which the support 200 is doped according to an embodiment of the present disclosure, FIG. 2B schematically shows the atomic structure of the core 110 supported on the support 200 according to an embodiment of the present disclosure, and FIG. 2C schematically shows the core 110 and the shell 120 of the intermetallic catalyst complex according to an embodiment of the present disclosure and the atomic structure in the core 110 and the shell 120.

A method of manufacturing an intermetallic catalyst complex for an electrochemical device according to some embodiments of the present disclosure may include preparing a first mixture by mixing a support 200 and a first heterometal precursor with a first solvent, doping the support 200 with a first heterometal (M1) by heating the first mixture, preparing a second mixture by mixing the support 200 doped with the first heterometal (M1), a platinum precursor, and a second heterometal precursor with a second solvent, forming a core 110 having an intermetallic structure by reducing platinum (Pt) and a second heterometal (M2) on the surface and inside of the first heterometal (M1) by heat treatment of the second mixture, and forming a shell 120 by removing the second heterometal (M2) located on the outermost surface of the core 110 by acid treatment of the core 110.

Individual steps are specified below, and specific details of the composition described in the “Intermetallic catalyst complex for electrochemical device,” such as the support, the first heterometal, the second heterometal, the intermetallic structure, etc., are omitted.

In order to dope the support 200 with the first heterometal, a first mixture may be prepared by mixing the support 200 and the first heterometal precursor with a solvent. As such, an organic precursor may also be added to the first mixture. Thereafter, the support 200 may be doped with the first heterometal (M1) by heating the first mixture.

The organic precursor is a material for doping the surface of the support 200 with at least one element of nitrogen (N), oxygen (O), or boron (B) during heat treatment of the first mixture, and nitrogen, oxygen, or boron may serve to assist in forming the first heterometal as metallic state particles rather than oxides by creating defective sites on the support 200. For example, in order for an oxide layer to be formed on the surface of the first heterometal, the bond between the already doped oxygen (or nitrogen, boron) and carbon has to be broken and the position has to be exchanged to the surface of the first heterometal, but it may be difficult for such reaction to occur during heating of the first mixture.

In some embodiments, at least one element of nitrogen (N), oxygen (O), or boron (B) with which the support 200 is doped may be derived from the organic precursor and may be used for doping during the process.

For example, when the first mixture obtained by adding the support 200, the first heterometal precursor, and the organic precursor to the first solvent is heated, the support 200 may be doped with oxygen rather than forming an oxide layer due to bonding of oxygen to the surface of the first heterometal. In this way, by doping the support 200 with the element such as nitrogen (N), oxygen (O), or boron (B) as well as the first heterometal, a phenomenon in which an oxide of the first heterometal is used for doping may be more effectively suppressed compared to using a support 200 already doped with the element such as nitrogen (N), oxygen (O), or boron (B), and the support 200 may be doped with the first heterometal in the form of particles to thus accelerate the formation of an intermetallic structure.

In some embodiments, the first heterometal (M1) precursor may include a compound in which the first heterometal (M1) is bonded to at least one functional group of an acetylacetonate group, a chloride group, a bromide group, an iodide group, a nitrate group, or a sulfate group.

In some embodiments, the organic precursor may include at least one of dicyandiamide (DCDA), urea, melamine, maleic acid, tartaric acid, boron acid, or cyanuric acid.

In addition, in some embodiments, the first heterometal precursor may be added so that the amount of the first heterometal satisfies 0.4 wt. % to 20 wt. % based on the weight of the support. If the amount of the first heterometal precursor that is added is too low, the effect of improving performance and durability of the intermetallic catalyst complex may not be sufficient, whereas if the amount of the first heterometal precursor that is added is too high, the Pt-M2 alloying effect may decrease due to an excess of first heterometal after heat treatment.

In some embodiments, the amount of the organic precursor may be 0.05 wt. % to 5 wt. % based on the total weight of the solid material excluding the first solvent in the first mixture. When the organic precursor is added to the first mixture in the above numerical range, it is possible to assist in doping the support 200 with the first heterometal in the form of metal particles without deteriorating performance of the manufactured intermetallic catalyst 100.

In some embodiments, as shown in FIG. 2A, the support 200 may be doped with the first heterometal (M1) by heating the first mixture to a temperature of 300° C. to 800° C.

Next, a second mixture may be prepared by mixing the support 200 doped with the first heterometal (M1), a platinum precursor, and a second heterometal precursor with a second solvent, in order to form a core 110 having an intermetallic structure. As such, the second mixture may be dispersed for a sufficient period of time using an ultrasonic disperser, a rotary stirrer, etc., as necessary.

Thereafter, the platinum (Pt) and the second heterometal (M2) may be reduced by heating the second mixture. In this process, as shown in FIG. 2B, platinum (Pt) and the second heterometal (M2) may be inserted into a unit cell of the first heterometal, causing lattice expansion and regular alloying.

In the core 110 thus formed, the region in which the amount of the first heterometal is high due to lattice expansion and an alloy (Pt-M1-M2) of platinum, the first heterometal, and the second heterometal is mainly formed may be referred to as a first core portion 111, and the region in which the amount of the first heterometal is low and an alloy (Pt-M2) of platinum (Pt) and the second heterometal (M2) is mainly formed may be referred to as a second core portion 112.

In some embodiments, the second heterometal (M2) precursor may include a compound in which the second heterometal (M2) is bonded to at least one functional group of an acetylacetonate group, a chloride group, a bromide group, an iodide group, a nitrate group, or a sulfate group.

In some embodiments, the platinum precursor is not particularly limited so long as it is able to provide platinum ions in a solvent, and may include, for example, at least one of chloroplatinic acid, platinum acetylacetonate, platinum chloride, platinum bromide, or platinum iodide.

In some embodiments, the second mixture may be heated to a temperature of 400° C. to 700° C. for 0.1 to 24 hours, thereby supporting a core 110 including the first heterometal, the second heterometal, and platinum on the support 200 as shown in FIG. 2B. According to an embodiment of the present disclosure, the first heterometal having a low melting point with which the support 200 is doped may serve to lower the energy barrier for regular structuring, causing regular structuring even under heat treatment conditions at a relatively low temperature.

Also, heat treatment of the second mixture may be performed in an inert atmosphere or a reducing atmosphere. In some embodiments, the inert atmosphere may be formed using an inert gas such as nitrogen gas or a Group 18 element gas, and the reducing atmosphere may be formed using a reducing gas in which a small amount of hydrogen gas is mixed with the inert gas. In addition, any gas may be used without particular limitation so long as it is understood as an inert gas or a reducing gas in the relevant technical field.

In some embodiments, the core 110 supported on the support 200 is subjected to acid treatment by adding the same to an acid solution, removing the second heterometal (M2) located on the outermost surface of the core 110 and thereby forming a shell 120. During this process, additional processes such as mixing, heating with stirring, drying, etc. may be performed as necessary.

Referring to FIGS. 2B and 2C, as the second heterometal located on the outermost surface of the core 110 is removed, the shell 120 composed mainly of platinum may be formed on the outside of the intermetallic catalyst 100. For reference, in FIGS. 2B and 2C, the second heterometal located on the outermost surface of the core 110 is depicted as being replaced with platinum, but it should be understood that the second heterometal is removed and a uniform platinum shell is formed.

In some embodiments, the acid solution used for acid treatment of the core 110 supported on the support 200 may include at least one of hydrochloric acid, sulfuric acid, nitric acid, or perchloric acid.

In some embodiments, the types of first solvent and second solvent are not particularly limited, and for example, at least one of deionized water (DI water), ethanol, acetone, propanol, butanol, toluene, or DMF (dimethylformamide) may be used.

### Membrane-electrode Assembly

Meanwhile, FIG. 4 shows a membrane-electrode assembly according to an embodiment of the present disclosure. The membrane-electrode assembly includes an electrolyte membrane 30, a cathode 10 formed on one surface of the electrolyte membrane 30, and an anode 20 formed on the remaining surface of the electrolyte membrane 30, and at least one of the cathode 10 or the anode 20 may include the intermetallic catalyst complex according to an embodiment of the present disclosure.

The anode 20 is an electrode that receives fuel such as hydrogen gas so that hydrogen is separated into protons and electrons by hydrogen oxidation reaction (HOR) and is also called a fuel electrode.

At the cathode 10, the protons moving from the anode 20 through the electrolyte membrane 30 and the electrons supplied from an external circuit are subjected to oxygen reduction reaction (ORR) along with oxygen gas supplied from the outside, generating electricity and heat and also producing water as a reaction byproduct, and the cathode is also called an oxygen electrode.

In the membrane-electrode assembly, an electrode for an electrochemical device to which the intermetallic catalyst complex according to an embodiment of the present disclosure is applied may be used as the anode 20 and/or the cathode 10, obtaining a fuel cell with excellent electrochemical performance and durability.

In addition, the electrolyte membrane 30 may be used without particular limitation so long as it is commonly used in the art. For example, a polymer (ionomer) with proton conductivity such as Nafion may be used. Also, an electrolyte membrane 30 in which a reinforced membrane such as e-PTFE is impregnated with the ionomer may be used.

A better understanding of the present disclosure may be obtained through the following examples and comparative examples. However, these examples are not to be construed as limiting the technical spirit of the present disclosure.

### EXAMPLE

In order to manufacture an intermetallic catalyst complex for an electrochemical device in which about 30 wt. % of platinum was loaded based on the total weight of the catalyst complex, the catalyst was synthesized using the following method.

A first mixture was prepared by adding an acetylene black-based carbon support, gallium acetylacetonate, and dicyandiamide (DCDA) to N,N-dimethylformamide (DMF) as a solvent. Thereafter, the first mixture was heated to about 400° C., preparing a carbon support doped with gallium.

Next, a second mixture was prepared by adding the carbon support doped with gallium, platinum acetylacetonate, and cobalt acetylacetonate to N,N-dimethylformamide (DMF) as a solvent. Thereafter, the second mixture was sufficiently dispersed using an ultrasonic disperser or a rotary stirrer, followed by heat treatment at about 500° C. for 10 hours in a reducing atmosphere (3% H₂/Ar), manufacturing a core supported on the carbon support. Here, the platinum precursor, the first heterometal precursor, and the second heterometal precursor were used so that the element ratio of Pt, M1, and M2 was about 3:0.2:0.8.

Next, the core supported on the carbon support was added to 0.1 M perchloric acid. The acid solution to which the core supported on the carbon support was added was sufficiently dispersed by ultrasonic treatment and then heated with stirring. As such, the heating temperature was about 60° C. and the heating time was about 2 hours. After heating, the resulting product was filtered and dried, thereby obtaining an intermetallic catalyst complex including the intermetallic catalyst supported on the carbon support.

### Comparative Example 1

A ternary intermetallic catalyst complex (PtNiGa/C) according to Comparative Example 1 was manufactured by adding an acetylene black-based carbon support, gallium acetylacetonate, and nickel acetylacetonate to DMF as a solvent to prepare a mixture followed by simultaneous reduction and heat treatment of the mixture at about 600° C. Here, the platinum precursor, the first heterometal precursor, and the second heterometal precursor were used so that the element ratio of Pt, M1, and M2 was about 1:0.2:0.8, and about 30 wt. % of platinum was loaded based on the total weight of the catalyst complex.

### Comparative Example 2

An intermetallic catalyst complex (PtNiGa/C with Pt-shell formed) according to Comparative Example 2 was manufactured by performing the acid treatment disclosed in Example using the intermetallic catalyst complex according to Comparative Example 1.

### Comparative Example 3

A binary intermetallic catalyst complex (PtNi/C) according to Comparative Example 3 was manufactured by adding an acetylene black-based carbon support and nickel acetylacetonate to DMF as a solvent to prepare a mixture followed by simultaneous reduction and heat treatment of the mixture at about 600° C. Here, the platinum precursor and the second heterometal precursor were used so that the element ratio of Pt and M2 was about 1:1, and about 30 wt. % of platinum was loaded based on the total weight of the catalyst complex.

### Test Example 1

In order to confirm the structure and composition of the intermetallic catalyst complex according to each of Example and Comparative Example 1, images were taken using high-angle annular dark-field scanning transmission electron microscopy (HAADF-STEM), and line scanning was performed using HAADF-STEM-EDS (energy dispersive spectroscopy).

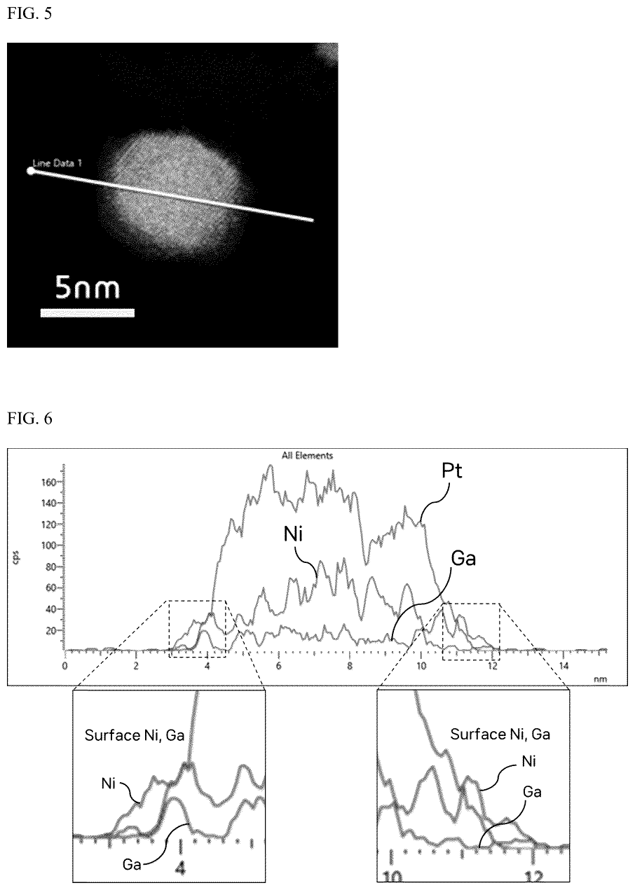

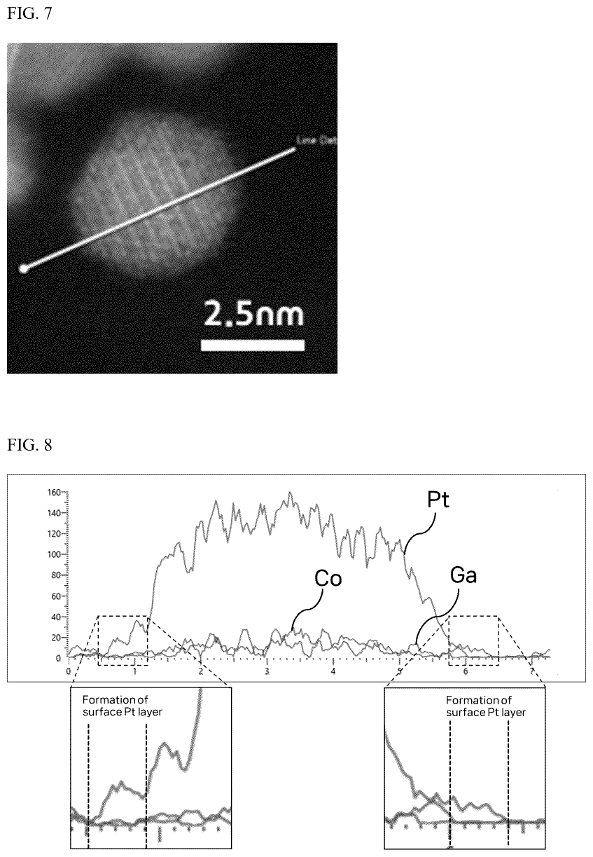

The results of HAADF-STEM and the results of line scanning of the intermetallic catalyst complex according to Comparative Example 1 are shown in FIGS. 5 and 6, respectively, and the results of HAADF-STEM and the results of line scanning of the intermetallic catalyst complex according to Example are shown in FIGS. 7 and 8, respectively.

Referring to the results of FIGS. 5 and 6, it was confirmed for the intermetallic catalyst complex according to Comparative Example 1 that nickel and gallium were also present on the surface of the intermetallic catalyst. Accordingly, when Comparative Example 1 is applied to the electrode of a fuel cell, dissolution is predicted to easily occur during operation of the fuel cell. In contrast, referring to FIGS. 7 and 8, it was confirmed for the intermetallic catalyst complex according to Example that the shell composed mainly of platinum was formed on the surface of the intermetallic catalyst. Furthermore, the first heterometal and the second heterometal were distributed in the core of the intermetallic catalyst, and in particular, the first heterometal was mainly distributed in the range of 2 nm to 5 nm, especially in the range of 3 nm to 4 nm.

### Test Example 2

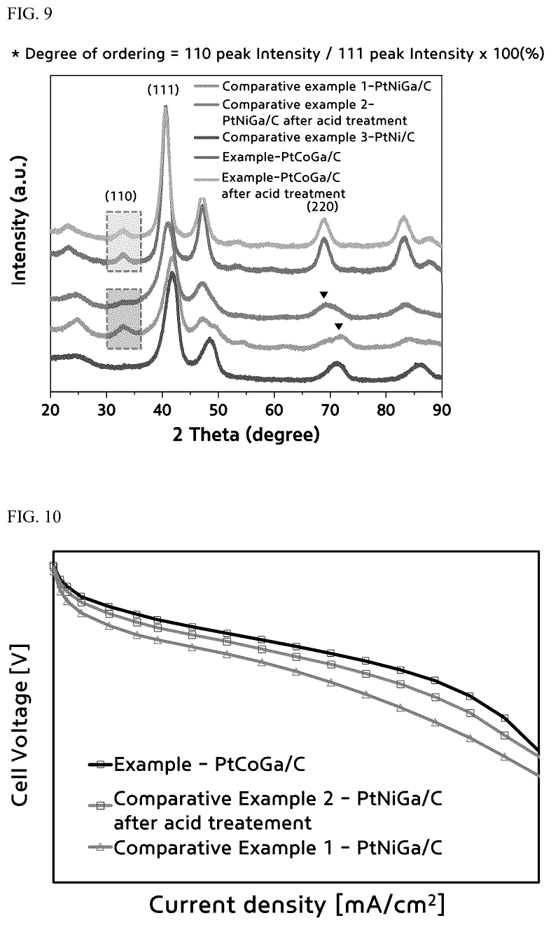

FIG. 9 shows results of X-ray diffraction (XRD) analysis before and after acid treatment in the process of manufacturing the intermetallic catalyst complex according to Example, and results of X-ray diffraction (XRD) analysis of the catalysts according to Comparative Examples 1 to 3. In FIG. 9, the peak observed at 2θ=32-38° may indicate the (110) plane, the peak observed at 2θ=39-43° may indicate the (111) plane, and the peak observed at 2θ=68-72° may indicate the (220) plane.

Referring to FIG. 9, when comparing Comparative Examples 1 and 2, the (110) peak was greatly decreased after acid treatment, and the degree of ordering was decreased from 12% to 3.6%. This is deemed to be because the first and second heterometals that were present on the surface were dissolved during acid treatment and thus the intermetallic structure disappeared. Also, the degree of alloying was confirmed to change due to dissolution of the first and second heterometals present on the surface, based on shifting of the (111) and (220) peaks to the left in Comparative Example 2 after acid treatment.

Based on the results of Comparative Examples 1 and 2, when the ternary intermetallic catalyst is manufactured by simultaneously reducing Pt, M1, and M2, it is vulnerable to an acid treatment environment, suggesting that the advantages of a catalyst having an intermetallic structure may not be utilized, and the first and second heterometals may be dissolved during operation of the fuel cell, causing deterioration of the membrane and the stack.

In Comparative Example 3, despite reduction and heat treatment at the same temperature, the distinct (110) peak was not observed, confirming that an intermetallic structure was not formed.

In contrast, in Example, the degree of ordering did not change before and after acid treatment, and the 2θ positions of the (111) and (220) peaks also did not change. Thereby, in the method of the present disclosure in which the first heterometal was placed at the core, an intermetallic structure was present in the core of the nanoparticles, indicating superior stability under acid conditions.

### Manufacture of Membrane-electrode Assembly

In order to verify performance of the manufactured catalyst, a membrane-electrode assembly was manufactured using the following method.

A cathode slurry was prepared by adding the intermetallic catalyst complex according to Example and Nafion (D2021) as an electrode binder to a solvent mixture of 100 g of NPA (n-propyl alcohol) and 100 g of water. As such, the weight ratio of the catalyst and the electrode binder was set so that the weight of the carbon support in the intermetallic catalyst complex and the weight of Nafion were 1:0.8.

In addition, an anode slurry was prepared by adding a known Pt/C catalyst and Nafion (D2021) as an electrode binder to the solvent mixture. As such, the weight ratio of the Pt/C catalyst and the electrode binder was set so that the weight of the carbon support of the Pt/C catalyst and the weight of Nafion were 1:1.

The cathode slurry was applied onto one surface of a known Nafion 211 electrolyte membrane, and the anode slurry was applied onto the remaining surface thereof, followed by drying and heat treatment, thereby manufacturing a membrane-electrode assembly including the cathode (oxygen electrode) and the anode (hydrogen electrode) with the electrolyte membrane interposed between the cathode and the anode. As such, the catalyst loading on the cathode was set to 0.15 mg_{Pt}/cm², and the catalyst loading on the anode was set to 0.05 mg_{Pt}/cm².

In addition, a membrane-electrode assembly was manufactured by applying the catalyst according to each of Comparative Examples 1 and 2 to the cathode in the same manner as above.

### Test Example 3

In order to verify electrochemical performance of the membrane-electrode assembly to which each of Example and Comparative Examples 1 and 2 was applied, charge and discharge experiments were performed from a low current density (0 A/cm²) to a high current density (about 2.5 A/cm² to 3 A/cm²) by keeping the current constant and recording the voltage when the voltage was stabilized, and voltage-current curves thereof are shown in FIG. 10.

Referring to FIG. 10, in Comparative Example 1, the first and second heterometals were exposed to the surface of the intermetallic catalyst, so the surface platinum active area was relatively small, confirming low catalytic performance. In Comparative Example 2, the first and second heterometals located on the surface were removed through acid treatment, but as confirmed in FIG. 9 and Test Example 2, the alloying effect was lowered due to disappearance of the intermetallic structure and a decrease in the amount of the transition metal (M2), resulting in inferior performance, compared to Example. In contrast, in Example, since the first heterometal was placed at the core, the surface platinum active area was large and the intermetallic structure was stable, confirming high activity.

### Test Example 4

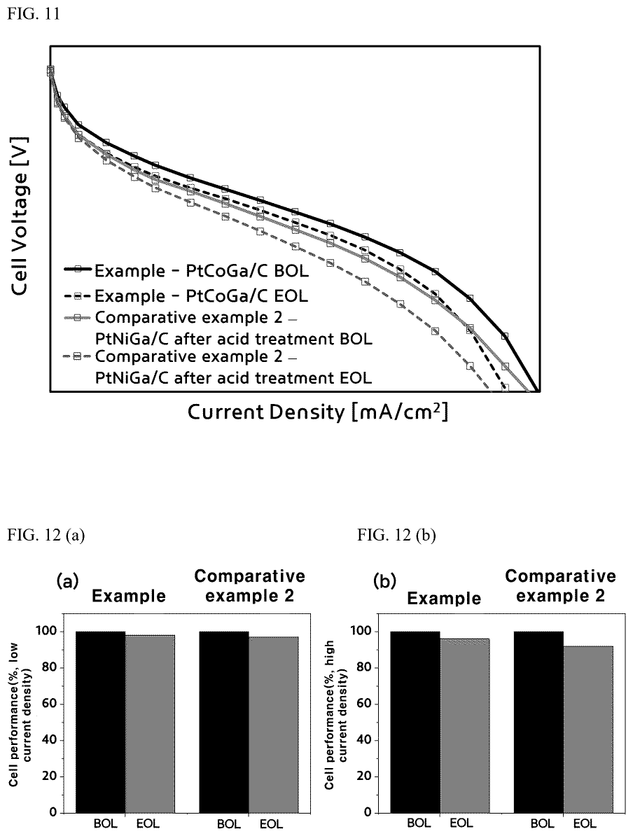

In order to verify durability of the membrane-electrode assemblies according to Example and Comparative Example 2, each membrane-electrode assembly was fastened with a gasket made of Teflon and a bipolar plate made of carbon at a pressure of 100 In*lb to manufacture a unit cell, followed by an accelerated degradation test (ADT) under the following conditions, and the results thereof are shown in FIGS. 11 and 12(a) and 12(b).

The ADT conditions are 0.6 V-0.95 V square wave, 3 seconds, 10,000 times; environmental conditions are RH 100%, 65° C., 1.0 bara, AN:H₂ 42 sccm CA:N₂ 134 sccm.

Referring to the results of FIGS. 11 and 12(a) and 12(b), Example, in which the first heterometal, which is a low-melting-point metal, was located at the core of the catalyst, exhibited vastly superior durability compared to Comparative Example 2. Specifically, in the low current density range, cell performance was decreased by about 2% at EOL compared to BOL in Example, whereas cell performance was decreased by about 3% at EOL compared to BOL in Comparative Example 2. Also, in the high current density range, cell performance was decreased by about 4% at EOL compared to BOL in Example, whereas cell performance was decreased by about 8% at EOL compared to BOL in Comparative Example 2.

In addition, Comparative Example 2, in which the first and second heterometals were removed from the surface through acid treatment, exhibited improved performance compared to Comparative Example 1, but had low platinum dissolution durability due to disappearance of the intermetallic structure compared to Example. Accordingly, it was confirmed that the catalyst structure according to Example was not only effective at maintaining the intermetallic structure but also contributed to improving performance and durability of the fuel cell.

As is apparent from the foregoing, according to an embodiment of the present disclosure, an intermetallic catalyst complex includes a transition metal, thus increasing the activity of oxygen reduction reaction and suppressing dissolution of the transition metal, thereby increasing durability.

In addition, according to an embodiment of the present disclosure, a process of manufacturing the intermetallic catalyst complex includes doping a support with a first heterometal having a relatively low melting point, so that the first heterometal is not exposed to the surface of the intermetallic catalyst complex, and the possibility of dissolution of the second heterometal is minimized.

The effects of the present disclosure are not limited to the foregoing. It should be understood that the effects of the present disclosure include all effects that can be inferred from the description of the present disclosure.

As the embodiments of the present disclosure have been described above, those skilled in the art will appreciate that various modifications and alterations are possible through change, deletion or addition of components without departing from the scope and spirit of the present disclosure as described in the accompanying claims, which will also be said to be included within the scope of rights of the present disclosure.

What is claimed is:

1. An intermetallic catalyst complex for an electrochemical device, the intermetallic catalyst complex comprising
a support; and
an intermetallic catalyst supported on the support, the intermetallic catalyst comprising:
a core having an intermetallic structure and comprising a first heterometal (M1), a second heterometal (M2), and platinum (Pt); and
a shell disposed on at least a portion of a surface of the core and comprising platinum (Pt).

2. The intermetallic catalyst complex of claim 1, wherein the core comprises:
a first core portion comprising platinum (Pt), a first heterometal (M1), and a second heterometal (M2); and
a second core portion that encases the first core portion and comprising platinum (Pt) and a second heterometal (M2).

3. The intermetallic catalyst complex of claim 2, wherein the second core portion further comprises a first heterometal (M1), and, in the second core portion, an amount of the second heterometal (M2) is greater than an amount of the first heterometal (M1).

4. The intermetallic catalyst complex of claim 1, wherein the support is doped with at least one of nitrogen (N), oxygen (O), or boron (B).

5. The intermetallic catalyst complex of claim 1, wherein the first heterometal (M1) comprises a metal having a melting point of 420° C. or lower.

6. The intermetallic catalyst complex of claim 1, wherein the first heterometal (M1) comprises at least one of gallium (Ga), zinc (Zn), tin (Sn), or selenium (Se).

7. The intermetallic catalyst complex of claim 1, wherein the second heterometal (M2) comprises at least one of cobalt (Co), nickel (Ni), iron (Fe), copper (Cu), manganese (Mn), or zinc (Zn).

8. The intermetallic catalyst complex of claim 1, wherein an average size of the core is about 1.5 nm to 4.5 nm.

9. The intermetallic catalyst complex of claim 1, wherein an average thickness of the shell is about 0.2 nm to 1.5 nm.

10. The intermetallic catalyst complex of claim 1, wherein the core exhibits an L1₀ or L1₂ crystal structure.

11. The intermetallic catalyst complex of claim 1, wherein an element ratio of platinum (Pt) to a sum of the first heterometal (M1) and the second heterometal (M2) in the intermetallic catalyst complex is about 1:1 to 5:1.

12. The intermetallic catalyst complex of claim 1, comprising about 0.1 wt. % to 10 wt. % of the first heterometal (M1) based on a total weight of the intermetallic catalyst complex.

13. The intermetallic catalyst complex of claim 1, wherein a degree of ordering, I₍₁₁₀₎/I₍₁₁₁₎*100 calculated from XRD analysis of the intermetallic catalyst complex is about 5% to 40%.

14. A method of manufacturing an intermetallic catalyst complex for an electrochemical device, the method comprising:
preparing a first mixture by combining a support, a first heterometal precursor, and an organic precursor with a first solvent;
heating the first mixture to dope the support with a first heterometal (M1);
preparing a second mixture by combining the doped support, a platinum precursor, and a second heterometal precursor with a second solvent;
heat-treating the second mixture to form a core having an intermetallic structure by reducing platinum (Pt) and a second heterometal (M2) on a surface and inside of the first heterometal (M1); and
acid-treating the core to remove the second heterometal (M2) located on an outermost surface of the core.

15. The method of claim 14, wherein metal particles of the first heterometal (M1) are used to dope the support.

16. The method of claim 14, wherein the support is doped with the first heterometal (M1) and at least one of nitrogen (N), oxygen (O), or boron (B) derived from the organic precursor by heating the first mixture, and
the organic precursor comprises at least one of DCDA (dicyandiamide), urea, melamine, maleic acid, tartaric acid, boric acid, or cyanuric acid.

17. The method of claim 14, wherein:
the first heterometal (M1) precursor comprises a compound in which the first heterometal (M1) is bonded to at least one functional group of an acetylacetonate group, a chloride group, a bromide group, an iodide group, a nitrate group, or a sulfate group,
the second heterometal (M2) precursor comprises a compound in which the second heterometal (M2) is bonded to at least one functional group of an acetylacetonate group, a chloride group, a bromide group, an iodide group, a nitrate group, or a sulfate group, and
the platinum precursor comprises at least one of chloroplatinic acid, platinum acetylacetonate, platinum chloride, platinum bromide, or platinum iodide.

18. The method of claim 14, wherein the organic precursor is present in an amount of 0.05 wt. % to 5 wt. % based on a total weight of a solid material in the first mixture.

19. The method of claim 14, wherein the first heterometal precursor is charged such that the first heterometal accounts for about 0.4 wt. % to 20 wt. % based on a weight of the support.

20. The method of claim 14, wherein the first mixture is heated at a temperature of about 300° C. to 800° C., and the second mixture is heated at a temperature of about 400° C. to 700° C.
